(19) United States
(12) Patent Application Publication
(10) Pub. No.: US 2017/0186452 A1
(43) Pub. Date: Jun. 29, 2017

(54) MAGNETIC RECORDING HEAD AND DISK DEVICE COMPRISING THE SAME

(71) Applicant: Kabushiki Kaisha Toshiba, Tokyo (JP)

(72) Inventors: Takuya Matsumoto, Tokyo (JP); Tomoko Taguchi, Kunitachi Tokyo (JP)

(21) Appl. No.: 15/059,890

(22) Filed: Mar. 3, 2016

(30) Foreign Application Priority Data
Dec. 25, 2015 (JP) 2015-254348

(51) Int. Cl. G11B 5/31

(52) U.S. Cl. CPC G11B 5/315

(57) ABSTRACT

According to one embodiment, a magnetic recording head includes an air bearing surface, a main pole including a tip end portion exposed to the air bearing face and configured to produce a recording magnetic field, a write shield opposing the tip end portion of the main pole with a write gap, a pair of side shields disposed on both sides of the main pole in a track-width direction, respectively, and a conductor provided between surfaces of each of the pair of side shields and the main pole over an entire track width of the side shields, to allow currents to flow in a plane direction of the air bearing surface.

### CROSS-REFERENCE TO RELATED APPLICATIONS

This application is based upon and claims the benefit of priority from Japanese Patent Application No. 2015-254348, filed Dec. 25, 2015, the entire contents of which are incorporated herein by reference.

### FIELD

Embodiments described herein relate generally to a magnetic recording head for use in a disk device and a disk device comprising the magnetic recording head.

### BACKGROUND

As a disk device, for example, a magnetic disk device comprises a magnetic disk accommodated in a case, a spindle motor configured to support and rotate the magnetic disk and a magnetic head configured to read/write data from/to the magnetic disk. The magnetic head includes a recording head for writing and a read head for reading.

In recent years, the magnetic head for vertical magnetic recording has been proposed to increase the recording density and capacity of the magnetic disk device, or to achieve miniaturization of the device. In such a magnetic head, the recording head includes a main pole which produces a magnetic field perpendicular to the recording surface of the magnetic disk and a write-shield magnetic pole opposed to the main pole via a write gap. Further, to suppress the degradation of recorded data by the return magnetic field from the main pole, a recording head in which both widthwise sides of the main pole are provided with side shields has been proposed.

It is expected that the recording head with such side shields, which can suppress magnetic field leakage in the width direction from the main pole, will be able to prevent the increase in erase width. However, in some cases, the magnetic flux in the main pole, the recording layer of the magnetic disk and the side shield affects part of the magnetization in the side shield to be directed perpendicular to the recording layer. As a result, when recording is repeatedly carried out on the same tracks, the following drawback may occur. That is, the magnetic field produced from directly beneath the side shield, which has a width spanning several tens of tracks, sometimes undesirably erase or degrade data recorded in a wide region over these tracks.

### BRIEF DESCRIPTION OF THE DRAWINGS

FIG. 1 is a perspective view showing a hard disk drive (hereinafter, HDD) according to a first embodiment.

FIG. 2 is a side view showing a magnetic head and a suspension in the HDD.

FIG. 3 is an enlarged sectional view showing a head portion of the magnetic head and a magnetic disk.

FIG. 4 is a perspective view schematically showing a recording head of the magnetic head.

FIG. 5 is a side view of a side end of an air bearing surface (ABS) of the recording head as viewed from a leading end side of a slider.

FIG. 6 is a plan view of the recording head as viewed from the air bearing surface side.

FIG. 7 is a diagram showing a comparison in magnetic field intensity distribution of a track width direction between the recording head of this embodiment and that of a comparative example (a typical recording head with a side shield).

FIG. 8 is a diagram showing a comparison in erase test result between the recording head of this embodiment and that of the comparative example.

FIG. 9 is a perspective view schematically showing a recording head of an HDD according to a second embodiment.

FIG. 10 is a plan view of the recording head according to the second embodiment as viewed from the air bearing surface side.

### DETAILED DESCRIPTION

Various embodiments will be described hereinafter with reference to the accompanying drawings. In general, according to one embodiment, a magnetic recording head comprises an air bearing surface; a main pole comprising a tip end portion exposed to the air bearing face and configured to produce a recording magnetic field; a write shield opposing the tip end portion of the main pole with a write gap; a pair of side shields disposed on both sides of the main pole a track-width direction, respectively; and a conductor provided between surfaces of each of the pair of side shields and the main pole over an entire track width of the side shields, to allow currents to flow in a plane direction of the air bearing surface.

What is disclosed in this specification is merely an example. Appropriate modifications which can be easily conceived by a person ordinarily skilled in the art without departing from the spirit of the embodiments naturally fall within the scope of the present invention. To further clarify explanation, for example, the width, thickness or shape of each structure may be schematically shown in the drawings compared with the actual forms. Note that the drawings are merely examples and do not limit the interpretation of the present invention. In the specification and drawings, elements which are identical to those of the already-mentioned figures are denoted by the same reference numbers. Thus, the detailed explanation of such elements may be omitted.

### First Embodiment

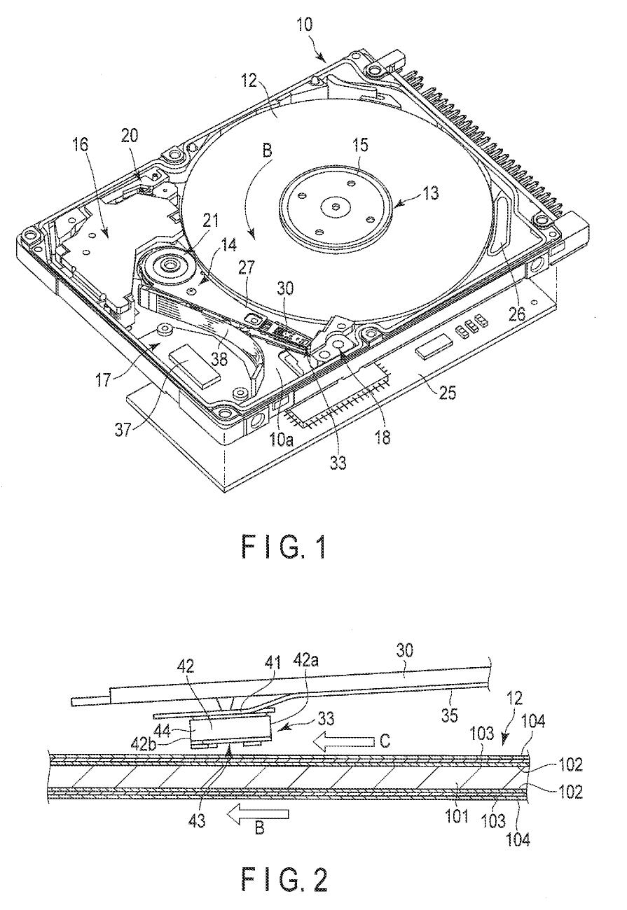

FIG. 1 shows an internal structure of an HDD according to a first embodiment, where a top cover is removed, and FIG. 2 shows a magnetic head 33 in a floating state. As shown in FIG. 1, the HDD comprises a housing 10. The housing 10 comprises a base 10a in the shape of a rectangle box whose upper surface is opened, and a top cover of a rectangular plate (not shown), which corresponds to the upper surface of the base 10a. The housing 10 is airtight, and can be ventilated only by way of, for example, an air-pass filter 26 communicating with the outside.

On the base 10a, a magnetic disk 12 as a recording medium and a drive section are provided. The drive section comprises a spindle motor 13 configured to support and rotate the magnetic disk 12; a plurality, for example, two, of magnetic heads 33 configured to write or read data on/from the magnetic disk 12; a carriage assembly 14 configured to support the magnetic heads 33 to be movable with respect to the surface of the magnetic disk 12; and a voice coil motor (VCM) 16 configured to rotate and position the carriage assembly 14. Further, a ramp load mechanism 18 configured to hold the magnetic heads 33 in a position spaced apart from the magnetic disk 12 when the magnetic heads 33 move to the outermost circumference of the magnetic disk 12, a latch mechanism 20 configured to hold the carriage assembly 14 in a retreating position when an impact or the like acts on the HDD, and a board unit 17 on which electronic components including a conversion connector 37 and the like are mounted are provided on the base 10a.

A control circuit board 25 is screwed to the outer surface of the base 10a and opposite to the bottom wall of the base 10a. The control circuit board 25 is configured to control operation of the spindle motor 13, and to control operations of the VCM 16 and the magnetic heads 33 via the board unit 17.

As shown in FIG. 1, the magnetic disk 12 is mutually coaxially fitted to a hub of the spindle motor 13 and also clamped by a clamp spring 15 screwed to the upper end of the hub to be fixed to the hub. The magnetic disk 12 is rotated by the spindle motor 13 as a drive motor in a direction indicated by arrow B at a predetermined speed.

The carriage assembly 14 comprises a bearing unit 21 mounted on the bottom wall of the base 10a, a plurality of arms 27 extending from the bearing unit 21 and a plurality of suspensions 30 in the form of an elongated plates, extending from the arms 27. The magnetic head 33 is supported on an extending end of each suspension 30. The arm 27 and the suspension 30 constitute a suspension assembly, and the suspension assembly and the magnetic head 33 form a head suspension assembly.

As shown in FIG. 2, each magnetic head 33 comprises a slider 42 substantially in the shape of a parallelepiped and a read/write head section 44 provided at an outflow end (trailing end) of the slider 42. The magnetic head 33 is fixed to a gimbal spring 41 provided in a tip portion of the suspension 30. Each magnetic head 33 is electrically connected to a relay FPC 38, which extends out from the board unit 17, via a trace member 35 fixed on the suspension 30 and the arm 27.

By passing a current to the voice coil of the VCM 16 while the magnetic disk 12 is rotating, the carriage assembly 14 is rotationally moved and the magnetic head 33 is moved and positioned on a desired track of the magnetic disk 12. At this point, the magnetic head 33 is moved between an inner circumferential edge and an outer circumferential edge of the magnetic disk radially with respect to the magnetic disk 12.

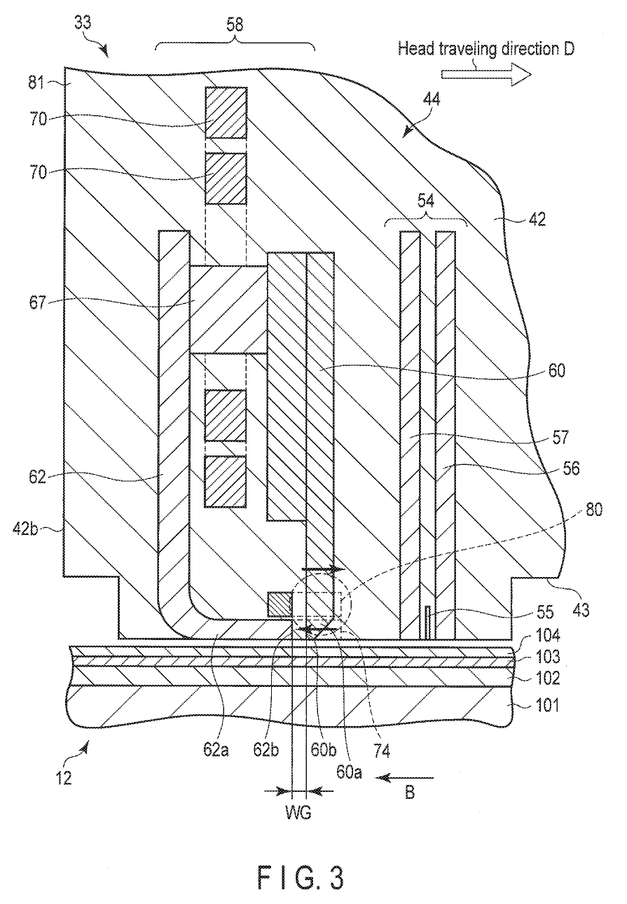

Next, the configuration of the magnetic disk 12 and the magnetic head 33 will be described in detail. FIG. 3 is an enlarged sectional view showing the head section 44 of the magnetic head 33 and the magnetic disk 12. As shown in FIGS. 1 to 3, the magnetic disk 12 comprises a discoid substrate 101 about, for example, 65 mm (2.5 inches) in diameter made of a nonmagnetic substance. A soft magnetic layer 102 made of a material exhibiting soft magnetic properties as a base layer, a recording layer 103 having magnetic anisotropy in a direction perpendicular to the disk surface as an upper layer thereof, and a protective film layer 104 as an upper layer thereof are stacked in this order on each surface of the substrate 101.

As shown in FIGS. 2 and 3, the magnetic head 33 is configured as a flying head and comprises the slider 42 formed substantially in the shape of a parallelepiped and the head section 44 provided at an outflow end (trailing end) 42b of the slider 42. The slider 42 is formed of, for example, a sintered body of alumina and titanium carbide (AlTiC) and the head section 44 is formed by stacking thin films.

The slider 42 comprises a rectangular air bearing surface (ABS) 43 opposite to the surface of the magnetic disk 12. The slider 42 is flied by an air flow C produced between the surface of the magnetic disk 12 and the ABS 43 by the rotation of the magnetic disk 12. The direction of the air flow C coincides with the direction of rotation B of the magnetic disk 12. The slider 42 is arranged in such a way that the longitudinal direction of the ABS 43 substantially coincides with the direction of the air flow C with respect to the surface of the magnetic disk 12.

The slider 42 comprises a leading end 42a located on the inflow side of the air flow C and a trailing end 42b located on the outflow side of the air flow C. On the ABS 43 of the slider 42, for example, a leading step, a trailing step, a side step and a negative-pressure cavity are formed (not shown).

As shown in FIG. 3, the head section 44 comprises a read head 54 and a recording head (magnetic recording head) 58 formed by a thin film process at the trailing end 42b of the slider 42 and is formed as a separate magnetic head. The read head 54 and the recording head 58 are covered by a nonmagnetic protective insulating film 81 except for a portion exposed to the ABS 43 of the slider 42. The protective insulating film 81 forms an outer shape of the head part 44.

The read head comprises a magnetic film 55 exhibiting the magneto-resistive effect and shielding films 56 and 57 arranged on a trailing side and a leading side of the magnetic film 55 to sandwich the magnetic film 55 therebetween. The lower ends of the magnetic film 55 and the shielding films 56 and 57 are exposed to the ABS 43 of the slider 42.

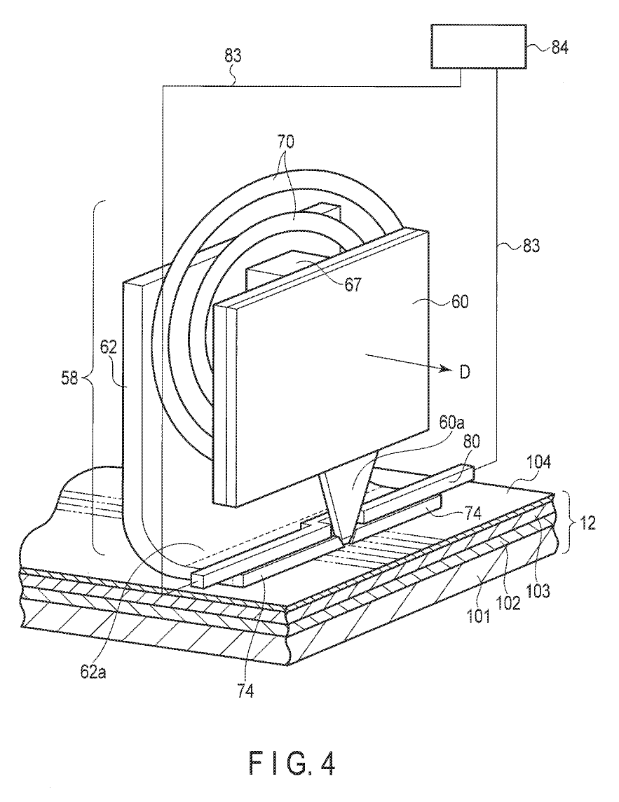

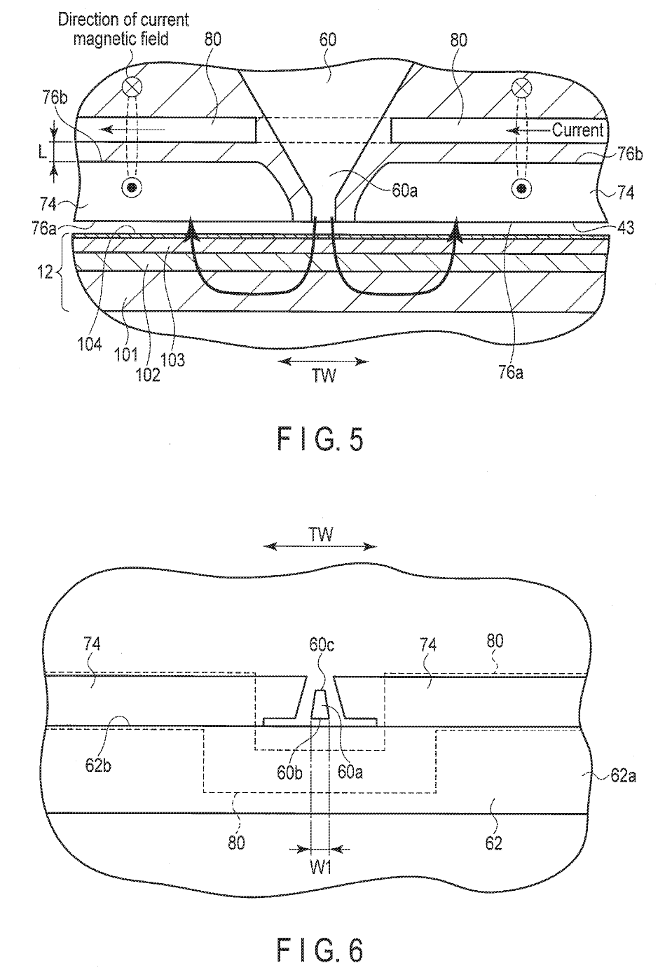

The recording head 58 is provided on the side of the trailing end 42b of the slider 42 with respect to the read head 54. FIG. 4 is a perspective view schematically showing the recording head and the magnetic disk, FIG. 5 is a side view of an ABS-side end portion of the recording head as viewed from the leading end side of the slider and FIG. 6 is a plan view of the recording head portion as viewed from the ABS side.

As shown in FIGS. 3 and 4, the recording head 58 comprises a main pole 60 which produces a recording magnetic field in a direction perpendicular to the surface (to the recording layer 103) of the magnetic disk 12, a write shield magnetic pole (trailing shield magnetic pole) 62 arranged on the ABS 43 on the trailing side of the main pole 60 with a write gap (first gap) WG therebetween, a junction 67 physically joining an upper portion of the main pole 60 to the write shield magnetic pole 62 and a recording coil 70 wound around a magnetic core including the main pole 60 and the write shield magnetic pole 62. The main pole 60 is made of a soft magnetic material having high magnetic permeability and high-saturation magnetic flux density, and a tip end thereof is exposed to the ABS 43. The write shield magnetic pole 62 is made from a soft magnetic material provided to efficiently close a magnetic path via a soft magnetic layer 102 of the magnetic disk 12 directly below the main pole 60.

The recording coil 70 is wound around the junction 67, for example, between the main pole 60 and the write shield magnetic pole 62. The current fed to the recording coil 70 from a write amplifier (not shown) is controlled by the control circuit board (control unit) 25 of the HDD. When a signal is written to the magnetic disk 12, a predetermined current is fed from the write amplifier to the recording coil 70 to produce a magnetic field by directing magnetic flux to the main pole 60.

As shown in FIGS. 3 to 6, the main pole 60 extends substantially perpendicularly to the ABS 43. A tip portion 60a of the main pole 60 on the ABS 43 side is narrowed by tapering down toward the ABS 43 and the surface of the magnetic disk 12 and is formed in a columnar shape narrower than other portions. A tip end surface of the main pole 60 is exposed to the ABS 43 of the slider 42. A width W1 of the tip portion 60a of the main pole 60 (width along the track width direction TW) approximately corresponds to the track width in the magnetic disk 12.

The write shield magnetic pole 62 is approximately L-shaped and a tip portion 62a thereof is formed as an elongated rectangle. A tip end surface of the write shield magnetic pole 62 is exposed to the ABS 43 of the slider 42. The tip portion 62a of the write shield magnetic pole 62 comprises a leading side end face (magnetic pole end face) 62b opposite to the tip portion 60a of the main pole 60. The length of the leading side end face 62b is sufficiently greater than the width W1 of the tip portion 60a of the main pole 60 and the track width of the magnetic disk 12 and extends in the width direction TW of the track of the magnetic disk 12. The leading side edge face 62b extends substantially perpendicular to the ABS 43. On the ABS 43, the lower end edge of the leading side end face 62b is opposite and parallel to a trailing side end face of the main pole 60 with the write gap WG therebetween.

As shown in FIGS. 3 to 6, the recording head 58 further comprises a pair of side shields 74 made of a soft magnetism material, which are arranged both sides of the main pole 60 in the track-width direction while being magnetically divided from the main pole 60 on the ABS 43, and a conductor (wiring member) 80 configured to produce a current magnetic field. The conductor 80 is provided between the side shields 74 and the surface of the main pole 60 which is opposed to the side shields 74 and extends over the entire width of the side shields 74.

The pair of side shields 74, formed of a material having high magnetic permeability, are formed integrally with the tip portion 62a of the write shield magnetic pole 62, and project toward the leading end side of the slider 42 from the leading side edge face 62b of the tip portion 62a. Each side shield 74 is formed to have such a width or thickness that it exceeds the leading side edge face 60c of the main pole 60 from the leading side edge face 62b of the write shield magnetic pole 62.

Each side shield 74 comprises a substantially rectangular lower surface (first surface) 76a, exposed to the ABS 43 and an upper surface (second surface) 76b apart from the ABS 43 in a height direction (direction away from the ABS) and opposing substantially parallel to the lower surface 76a. A main-pole-side end of the lower surface 76a is opposite to the main pole 60 with a gap therebetween.

As shown in FIGS. 3 to 6, the conductor 80 is provided between the side shields 74 and the main pole 60 to be opposite to the upper surface 76b of the side shields 74 and extends over the entire track width of the side shields 74. That is, the conductor 80 is arranged so that the side shields 74 are interposed between the conductor 80 and the ABS 43. The conductor 80 is disposed substantially parallel to the upper surfaces 76b of the side shields 74 and the ABS 43 so as to be apart only a distance L (for example, 100 nm) from the upper surfaces 76b of the side shields 74 in the height direction (direction perpendicular to the ABS 43).

In this embodiment, a central portion of the conductor 80 is bent to the write shield magnetic pole 62 side and extends over the tip portion 60a of the main pole 60. Both longitudinal ends of the conductor 80 are electrically connected to the current source (power supply) 82 of the HDD through interconnects 83 and the trace member 35 described above. The conductor 80 is formed of, for example, a conductive material such as copper or aluminum and the thickness, the distance L and the current through the conductor 80 are set appropriately according to the intensity of the magnetic field due to the current, produced around the conductor 80 and the intensity of the magnetic field due to the current acting on the side shield 74.

As shown in FIGS. 3 and 4, if a direct or alternating current from the current source 84 is passed through the conductor 80, the current flows substantially parallel to the ABS 43 through the conductor 80, producing concentric with the conductor 80 a current magnetic field. The magnetic field due to the current acts on the side shields 74 in the plane direction of the ABS 43. Thus, the direction of magnetization of each side shield 74 is set in the in-plane direction parallel to the ABS 43, that is, the in-plane direction substantially parallel to the recording layer of the magnetic disk 12. With this arrangement, it is possible to suppress the occurrence of the leak magnetic field in a direction perpendicular to the ABS 43 from the side shields 74.

Note that the current may be supplied to the conductor 80 continuously at all times, or may be at the time of data recording operation in synchronism with the current supply to the recording coil 70. Moreover, the conductor 80 may not be completely parallel to the ABS 43, but may incline slightly with respect to the ABS 43.

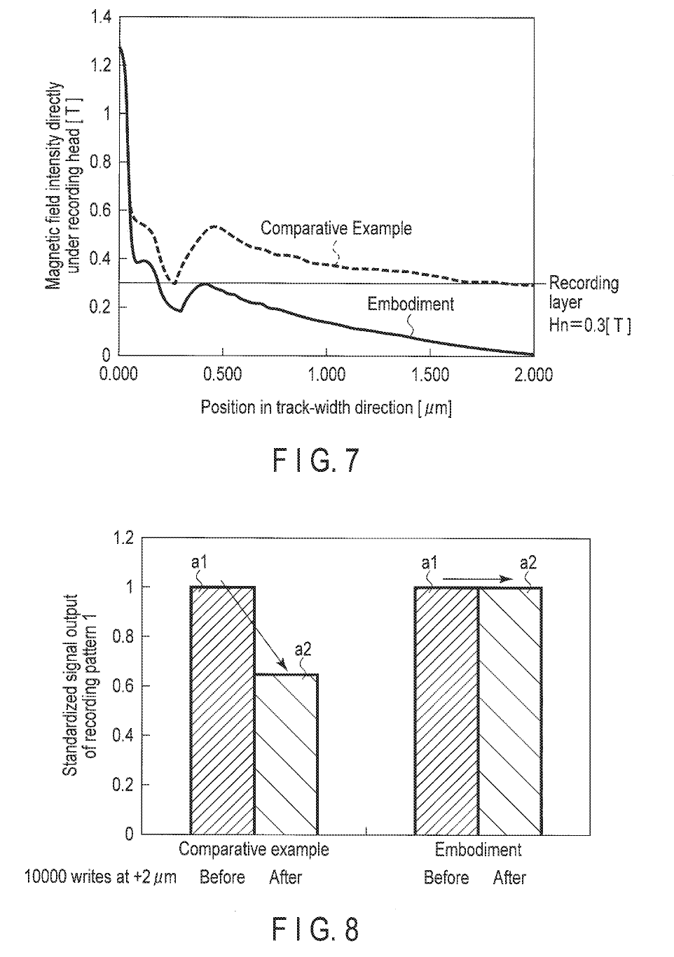

FIG. 7 is a diagram showing a comparison in magnetic field intensity distribution in the track width direction between the recording head with the conductor according to this embodiment and a recording head (a typical recording head with side shields) of a comparative example. In other words, FIG. 7 shows a comparison between a profile of distribution of the recording magnetic field in an off-track direction when the recording head of the comparative example is used and that of the recording head of the present embodiment when the distance L of the conductor 80 is set to 100 nm.

In FIG. 7, the location where the track-width direction is equal to zero is the center position (track center) of the main pole 60 of the recording head in the track-width direction. A characteristic line represented by the dashed line is a head magnetic field distribution produced from directly under the recording head according to the comparative example, and is obtained by plotting the maximum magnetic field at various points on one side with respect to the track center along the off-track direction are plotted. A characteristic line represented by the solid line is a head magnetic field distribution produced from directly under the recording head according to this embodiment, and is obtained by plotting the maximum magnetic field at various points on one side with respect to the track center along the off-track direction are plotted.

As indicated by the solid characteristic line, the recording head according to this embodiment can suppress the fringe field even at a 2-μm position in the off-track direction while maintaining the magnetic field strength in the track center directly under the main pole 60 as compared to the recording head of the comparative example. If the fringe field in the off-track direction has a value greater than that of the nuclear magnetic field (Hn) of a recording layer of the recording medium, the magnetization of the recording layer deteriorates. For example, the graph indicates that when a recording medium with Hn=0.3 T was used, the recording head of the comparative example had a magnetic field intensity higher than Hn=0.3 T within a range of 2 μm in the track-width direction, and the recorded signal deteriorates within this 2-μm range. By contrast, with the recording head of this embodiment, the fringe field within a range of 0.5 to 2 μm is no more than Hn, and therefore the degradation of the recorded signal does not occur. Thus, it is understood that when, for example, an HDD having a recording track width of 50 (nm) is used, a signal deterioration for 40 tracks can be suppressed.

FIG. 8 is a diagram showing a comparison in erase test result between the recording head of this embodiment and that of the comparative example. Here, the nuclear magnetic field Hn, that is, a magnetic property of the recording layer of the magnetic disk, is 0.3 T.

In FIG. 8, the 0-μm position in the track-width direction was set at the center position (support center) of the main pole 60 of the recording head 58 along the track-width direction. Here, a recording pattern 1 was written at a certain frequency at a track-width position of 0 μm and then the recording pattern 1 was reproduced to measure a signal output a1, and also a signal was written at a frequency different from that of the recording pattern 1 in 10,000 times at a track-width position of +2 μm and then the recording pattern 1 was again reproduced to measure a signal output a2. FIG. 8 shows the results of the measurements of signal output a1 and signal output a2 for the recording head of the embodiment and that of the comparative example. In this graph, the signal output reproduced immediately after writing the recording pattern 1 is standardized as 1 in value.

As can be understood from FIG. 8, with the recording head of the comparative example, the signal output of the recording pattern 1 is deteriorated by the magnetic field directly under the side shield. On the other hand, in the recording head of this embodiment, the magnetic field directly under the side shield 74 is fully controlled as compared to the nuclear magnetic field Hn of the recording layer, and therefore the signal quality of the recording pattern 1 does not deteriorate.

According to the magnetic recording head and magnetic disk device of the embodiment configured as above, the conductor provided between the main pole and the surface of the side shields opposing thereto produces a magnetic field due to a current which directs the magnetization of the side shields in the in-plane direction of the recording layer (the ABS of the head) of the recording medium. Therefore, the fringe field leaking from the side shield to the recording layer is be reduced, thereby making it possible to suppress the production of the magnetic field which may erase or degrade the already recorded data. With this configuration, the erase or degradation of already recorded data can be suppressed in a wide neighboring track region over several tens of tracks on the magnetic disk while maintaining the quality of the on-track signals of the magnetic disk, thus making it possible to achieve long-term data storage. Thus, it is possible to provide such a magnetic recording head and magnetic disk device with improved reliability.

Next, a recording head of an HDD according to another embodiment will now be described. Note that in the description of the following embodiment, those portions that are the same as those of the first embodiment will be given the same reference numbers and their detailed explanation will be omitted. Only those portions that are different from the first embodiment will be mainly explained in detail.

### Second Embodiment

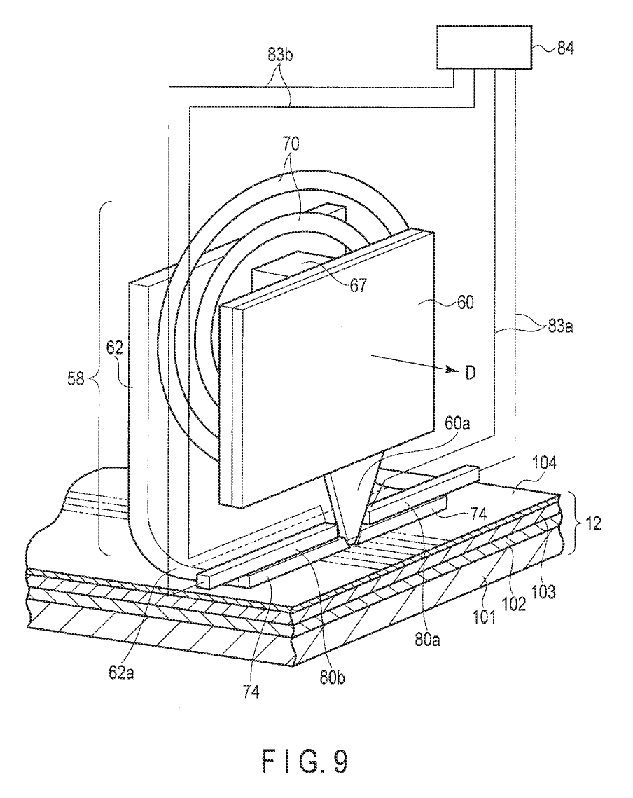

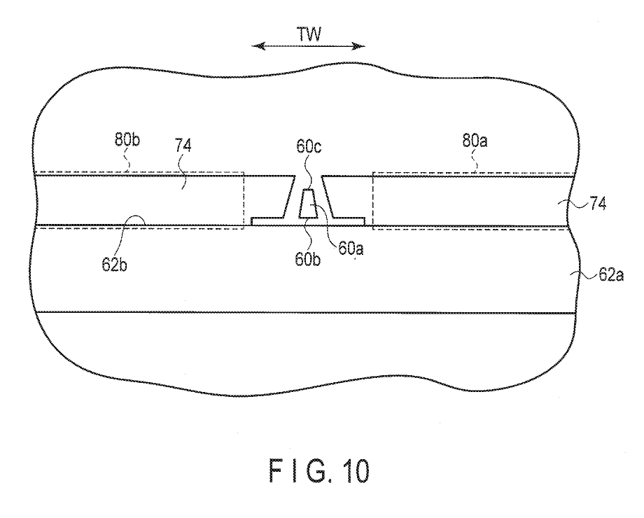

FIG. 9 is a perspective view schematically showing a recording head of an HDD according to the second embodiment, and FIG. 10 is a plan view of the recording head of the second embodiment as viewed from the air bearing surface side.

According to the second embodiment, the conductor 80 comprises independent two conductors, namely, a first conductor 80a provided on one of the side shields 74 and a second conductor 80b provided on another of the side shields 74.

The first conductor 80a is provided to oppose an upper surface of the side shield 74 between the one of the side shields 74 and the main pole 60, and further to extend over the entire track width of the one of the side shields 74. More specifically, the first conductor 80a is disposed so that the one of the side shields 74 is interposed between the first conductor 80a itself and the ABS 43. Further, the first conductor 80a is placed substantially parallel to the upper surface of the one of the side shields 74 and the ABS 43, to be separated by only a distance L (for example, 100 nm) in the height direction (direction perpendicular to the ABS 43) from the upper surface of the side shield 74. Both longitudinal ends of the first conductor 80a are electrically connected to the current source 84 through interconnects 83a and the above-described trace member.

The second conductor 80b is provided to oppose the upper surface of the other side shield 74 between the other side shield 74 and the main pole 60, and further to extend over the entire track width of the other side shield 74. More specifically, the second conductor 80b is disposed so that the other side shield 74 is interposed between the second conductor 80b itself and the ABS 43. Further, the second conductor 80b is placed substantially parallel to the upper surface of the other side shield 74 and the ABS 43, to be separated by only a distance L (for example, 100 nm) in the height direction (direction perpendicular to the ABS 43) from the upper surface of the side shield 74. Both longitudinal ends of the second conductor 80b are electrically connected to the current source 84 through interconnects 83b and the above-described trace member.

If a direct or alternating current is supplied to the conductors 80a and 80b from the current source 84, the currents flow substantially parallel to the ABS 43 through the conductors 80a and 80b, to produce concentric therewith magnetic fields due to currents through the conductors 80a and 80b. The magnetic fields due to the currents act on the side shield 74 in the plane direction of the ABS 43. Thus, the direction of magnetization of each side shield 74 is set in an in-plane direction parallel to the ABS 43, namely, the in-plane direction substantially parallel to the recording layer of the magnetic disk 12, thereby making it possible to suppress the production of the fringe field leaking from the side shield 74 in a direction perpendicular to the ABS 43.

In addition, the currents may be supplied to the conductors 80a and 80b continuously at all times, or in synchronism with the current supply to the recording coil 70 only when recording data. Moreover, the conductors 80a and 80b may not necessarily be completely parallel but to the ABS 43, but may incline slightly with respect thereto.

In the second embodiment described above, an effect similar to that of the first embodiment can be obtained. That is, it is possible to provide such a magnetic recording head and magnetic disk device with improved reliability, in which the erase or degradation of already recorded data can be suppressed in a wide neighboring track region over several tens of tracks on a magnetic disk while maintaining the quality of the on-track signals of the magnetic disk, thus making it possible to achieve long-term data storage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the materials, shapes and sizes of elements constituting the head unit can be changed depending on the need. Further, in the magnetic disk device, the number of magnetic disks or magnetic recording heads may be increased as needed, and the size of the magnetic disk may be selected from various types.

1. A magnetic recording head comprising:
an air bearing surface;
a main pole comprising a tip end portion exposed to the air bearing surface and configured to produce a recording magnetic field;
a write shield opposing the tip end portion of the main pole with a write gap;
a side shield disposed on a side of the main pole, the side shield comprising a first surface exposed to the air bearing surface and a second surface opposing the first surface and spaced from the air bearing surface in a height direction;
a conductor disposed to oppose the second surface of the side shield at a predetermined distance; and
an insulating layer located between the conductor and the air bearing surface.

2. The magnetic recording head of claim 1, further comprising a pair of side shields including the side shield, disposed on both sides of the main pole, wherein
each of the side shields comprises a first surface exposed to the air bearing surface and a second surface opposing the first surface and spaced from the air bearing surface in a height direction and the conductor is disposed to oppose the second surface of each of the side shields at a predetermined distance.

3. The magnetic recording head of claim 2, wherein the conductor comprises a first conductor arranged to oppose the second surface of one of the side shields with a gap and to extend over an entire length of the one of the side shields in a track-width direction and a second conductor arranged to oppose the second surface of the other of the side shields with a gap and to extend over an entire length of the other of the side shields in a track-width direction.

4. The magnetic recording head of claim 1, further comprising:
a recording coil wound around a magnetic core including the main pole and the write shield so as to allow a magnetic flux to flow the main pole.

5. The magnetic recording head of claim 2, wherein a thickness of the conductor, a distance between the conductor and the side shields and a current allowed to flow through the conductor are set according to an intensity of a magnetic field due to the current, produced around the conductor when the current flows therethrough and acting on the side shields in a plane direction.

6. The magnetic recording head of claim 3, wherein a thickness of the conductor, a distance between the conductor and the side shields and a current allowed to flow through the conductor are set according to an intensity of a magnetic field due to the current, produced around the conductor when the current flows therethrough and acting on the side shields in a plane direction.

7. A disk device comprising:
a disk-shaped recording medium including a recording layer having magnetic anisotropy perpendicularly to a surface of the recording medium;
a magnetic recording head of claim 1, configured to write data to the recording medium; and
a current supply configured to supply a direct or alternating current to the conductor of the magnetic recording head.

8. The disk device of claim 7, wherein
the current supply is configured to supply the current to the conductor as a member independent from a recording coil of the magnetic recording head.

9. The disk device of claim 7, wherein
the current supply is configured to supply a current to the conductor in synchronism with the current flow to a recording coil of the magnetic recording head.
